(19) United States
(12) Patent Application Publication
(10) Pub. No.: US 2015/0191398 A1
(43) Pub. Date: Jul. 9, 2015

(54) METHOD FOR CREATING PATTERNS ON A CONCRETE SURFACE

(71) Applicant: CHRYSO, Issy les Moulineaux (FR)

(72) Inventors: Philippe Pucel, Verneil le Chetif (FR); Amélie Burleraux, Puiseaux (FR); Isabelle Nieuweboer-Maignan, Amsterdam (NL)

(73) Assignee: CHRYSO, Issy les Moulineaux (FR)

(21) Appl. No.: 14/410,736

(22) PCT Filed: Jul. 3, 2013
(86) PCT No.: PCT/EP2013/064056

§ 371 Date: Dec. 23, 2014

(30) Foreign Application Priority Data
Jul. 4, 2012 (FR) 12 56422

(51) Int. Cl. C04B 41/52; C04B 41/48; C04B 41/53; C04B 41/47

(52) U.S. Cl. CPC C04B 41/522; C04B 41/472; C04B 41/4861; C04B 41/53

(57) ABSTRACT

The present invention relates to a method for creating patterns on a surface of the hydraulic binder composition comprising the deposition on the surface of the fresh hydraulic binder composition of a stencil and then application of a deactivating composition (A) on the thereby covered surface.

The present invention relates to a method for creating patterns on a concrete surface.

### TECHNOLOGICAL BACKGROUND

Concrete is the handiest construction material in making elements which may have very diverse shapes and aspects.

Deactivated concrete, for which the granulates are apparent, notably gives the possibility of making it available in a wide palette of aspects and colors. It is encountered on ground building sites (pavements, places, parking areas, yards, pathways . . . ) but also in the manufacturing of urban furniture (flower pots, garbage bins . . . ), gravel slabs or further wall panels.

The final aspect of deactivated concrete mainly depends on its composition. In particular, the granulates used may be of different sizes, shapes and colors (white marble, red rocks . . . ). Moreover, the color of the cement may add a specific touch, since it may be selected to be grey, white or colored with a coloring agent.

The production of deactivated concrete requires the use of an agent able to delay the setting of the concrete at the surface. This agent is generally called <<a surface deactivating agent>>, or <<a setting retardant>>.

It may be interesting, for esthetical reasons, to include elements in the concrete, etc. to have available a method allowing creation of patterns at the surface of the concrete, these patterns may be created by deactivating desired areas of the surface of the concrete.

### STATE OF THE ART

From U.S. Pat. No. 4,055,322 is notably known a method for creating patterns on a concrete surface comprising the positioning in a mold of a membrane having one face permeable to water comprising on one of its surfaces patterns delimited by a setting retardant soluble in water, an impervious film totally covering the patterns. The concrete is then cast onto the membrane, on the side pervious to water.

From US20070164484 is also known a method for creating patterns on a concrete surface in molded parts comprising the deposition on the bottom of the mold or on a support deposited at the bottom of the mold of a deactivating agent and then applying a stencil on the bottom of the mold or on the support thereby covered with a deactivating agent. The concrete is then cast on the stencil. From patent application EP 1 177 081 membranes are known, comprising a deactivating agent creating patterns on said membrane. The membrane is laid at the bottom of the mold and the concrete is cast, the deactivating agent of the membrane allowing the patterns of the membrane to be transferred to the concrete.

However, these methods are negative deactivation methods which can only be applied in the case of molded parts.

### SHORT DESCRIPTION OF THE INVENTION

There is therefore a benefit of providing a method allowing the creation of patterns on the surface of a concrete allowing the production of non-molded parts.

An object of the present invention is therefore to provide a method for creating a pattern on the surface of a non-molded concrete, an application also designated as positive deactivation.

Another object of the present invention is to provide such a method which allows limitation of the appearance of unesthetical bubbles or air lenses at the surface of the concrete, notably at the interface between the stencil and the surface of the concrete.

Other objects will further appear upon reading the invention which follows.

### DETAILED DESCRIPTION OF THE INVENTION

The present invention relates to a method for creating patterns on a surface of a hydraulic binder composition, comprising the deposition on the surface of the fresh hydraulic binder composition of a stencil and then application of a deactivated composition (A) on the thereby covered surface.

In a particular embodiment, the method according to the invention may further comprise a step, prior to the deposition of the stencil, for applying on all or part of the surface of the hydraulic binder composition, a deactivating composition (B) having a lower strength of attack than that of the composition (A).

Upon contacting the surface of the fresh hydraulic binder composition, the deactivating composition penetrates by diffusion over a certain depth and induces therein a setting delay. The depth of the delayed layer by the deactivating composition also called digging capacity or strength of attack, will be mainly selected according to the size of the present granulates. The goal is to make granulates appear at the surface, thus, the attack strength will depend on the sought esthetical effect as well as on the size of the granulates. The deactivating composition will have to be selected depending on the desired effect, typically, the bigger the granulates the more the composition will have to exhibit a significant strength of attack.

After setting of the surface and withdrawal of the stencil, the delayed concrete layer remains friable at the surface and may be removed, so as to show the granulates at the surface of the part, giving a particular esthetical aspect to the material. The delayed surface may be removed, after a delay from 8 to 24 h, by washing with a high pressure water jet or by brushing.

By the term of <<hydraulic binder>> is meant any compound having the property of hydrating in the presence of water and for which hydration gives the possibility of obtaining a solid having mechanical characteristics. The hydraulic binder may be a cement according to the EN 197-1 standard and notably a cement of the CEM I, CEM II, CEM III, CEM IV or CEM V type according to the French standard Ciment NF EN 197-1. The cement may therefore in particular comprise mineral additions.

The expression of <<mineral additions>> refers to slags (as defined in the Ciment NF EN 197-1 paragraph 5.2.2 standard), steelworking slags, pozzolanic materials (as defined in the Ciment NF EN 197-1 paragraph 5.2.3 standard), flying ashes (as defined in the Ciment NF EN 197-1 paragraph 5.2.4 standard), calcined shales (as defined in the Ciment NF EN 197-1 paragraph 5.2.5 standard), limestones (as defined in the Ciment NF EN 197-1 paragraph 5.2.6 standard) or further silica fumes (as defined in the Ciment NF EN 197-1 paragraph 5.2.7 standard) or mixtures thereof. Other additions, not presently recognized by the Ciment NF EN 197-1 (2001) standard may also be used. These are notably metakaolins, such as metakaolins of type A according to the NF P 18-513 standard, and siliceous additions, such as siliceous mineralogy additions Qz according to the NF P 18-509 standard.

The compositions based on a hydraulic binder according to the invention are preferably concrete compositions.

By the term of <<concrete>>, is meant a mixture of hydraulic binders, of granulates, of sands, of water, optionally of additives, and optionally of mineral additions. The term of <<concrete>> also comprises mortars.

The term of <<fresh>> intends to describe such compositions based on the hydraulic binder when they have been mixed with water, and have not yet set.

By the term of <<setting>> is meant the passing to the solid state by a hydration reaction of the binder.

In order to allow time for the operator to place the stencil, to optionally smooth the surface and apply the deactivating composition (A), it may be necessary to delay the setting of the hydraulic binding composition and/or to increase its workability or its open time. The hydraulic binding composition may thus advantageously have an open time of at least 30 minutes, preferably from 30 minutes to 4 hours. The setting delay and/or the increase of its workability may be provided by the use of a retardant and/or fluidifying additive in the hydraulic binding composition. Thus, in an advantageous way, the hydraulic binding composition may further comprise at least one retarding and/or fluidifying additive. The retarding and/or fluidifying additives may be any additive known to one skilled in the art and fulfilling this function.

Within the scope of the present invention, by open time is meant the time during which the concrete may be handled, i.e. the duration during which the spreading or the collapse of the cement composition is greater than 50% of the initial value, this value being measured by the collapse height of the Abrams cone according to the French standard NF EN12350-2 or by spreading out with the Abrams cone according to the NF EN12350-8 standard.

Within the scope of the invention, by a setting retardant is meant a compound having the effect of delaying the setting of the concrete, i.e. delaying or inhibiting the phenomena related to this setting such as hydration phenomena, inducing consequently belated curing of the composition. Such compounds are well known to one skilled in the art. Generally, a setting retardant extends the elapsed time for setting a composition based on a hydraulic binder in which it has been introduced at a dose of at most 5% by dry weight based on the weight of said hydraulic binder, the setting time being measured according to the EN480-2 test. Preferably, the setting time is extended by at least 30 minutes as compared with a composition based on a control hydraulic binder.

Within the scope of the invention, by fluidifying additive or water-reducing additive is meant an additive allowing reduction in the amount of water required for producing a concrete.

The retarding and/or fluidifying additive may be selected from the family of comb structure polymers, compounds comprising a polyalkoxylated chain and at least one amino-alkylene phosphonic group, gluconic acid, sugars, lignosulfonic acid, polynaphthalene sulfonic acid, polymelamine sulfonic acid and their salts; alone or as a mixture.

The polymers with a comb structure are notably selected from comb copolymers with a main polycarboxylate chain bearing lateral chains grafted with poly(alkyleneoxide) (or PCP).

The compounds comprise a polyalkoxylated chain and at least one amino-alkylene phosphonic group may be selected from the compounds of formula (I):

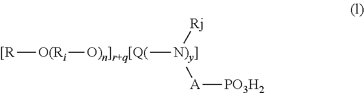

wherein:

R is a hydrogen atom or a monovalent hydrocarbon group including from 1 to 18 carbon atoms and optionally one or several heteroatoms;

the Rᵢ are similar or different from each other and represent an alkylene like ethylene, propylene, butylene, amylene, octylene or cyclohexene, or an arylene like styrene or methylstyrene, the Rᵢ optionally contain one or several heteroatoms;

Q is a hydrocarbon group including from 2 to 18 carbon atoms and optionally one or several heteroatoms;

A is an alkylidene group including from 1 to 5 carbon atoms;

the Rⱼ are similar or different from each other and may be selected from:
the A-PO₃H₂ group, A having the aforementioned meaning,
the alkyl group including from 1 to 18 carbon atoms and which may bear [R—O(Rᵢ—O)ₙ] groups, R and Rᵢhaving the aforementioned meanings,
and the group

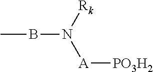

Rₖ designating a group such as Rⱼ, preferably Rₖ is selected from an A-PO₃H₂ group, A having the aforementioned meaning; and an alkyl group including from 1 to 18 carbon atoms and which may bear [R—O(Rᵢ—O)ₙ] groups, R and Rᵢ having the aforementioned meanings;
B designating an alkylene group including from 2 to 18 carbon atoms,
“n” is a number greater than or equal to 0,
“r” is the number of [R—O(Rᵢ—O)ₙ] groups borne by the whole of the Rj,
“q” is the number of [R—O(RᵢO)ₙ] groups borne by Q, the sum
“r+q” is comprised between 1 and 10,
“y” is an integer comprised between 1 and 3,
Q, N and the Rⱼ may form together one or several rings, these ring(s) may further contain one or several other heteroatoms.

A polyalkoxylated polyphosphonate is particularly preferred, consisting of a water-soluble or water-dispersible organic compound including at least one amino-di-(alkylene-phosphonic) group and at least one polyoxyalkylated chain or at least one of its salts. In particular, the compounds of formula (I) wherein R is a methyl group, the Rᵢ are ethylene and propylene groups, n being comprised between 30 and 50, r+q has the value 1, Q is an ethylene group, A is a methylene group, y has the value 1 and Rⱼ corresponds to the CH_{2—PO}₃H₂ group.

Such compounds are notably described in patent EP 0 663 892. Preferably, this compound is notably contained in the product Chryso®Fluid Optima 100 available from Chryso.

As a particular example of a retarding and/or fluidifying additive contained in the product, mention may be made of Chryso®Fluid Optima 100 and Chryso®Fluid Optima 175 available from Chryso.

The sugars may be selected from glucose, fructose, saccharose, Meritose, lactose, maltotriose, dextrose, maltose, galactose, mannose, glycogen, or one of their mixtures.

The additive may preferably be selected from comb copolymers with a main polycarboxylate chain bearing lateral chains grafted with polyalkyleneoxide (or PCP) or compounds of formula (I), or a mixture thereof.

Preferably, the additive content in the hydraulic binding composition is from 0.2 to 3% by dry weight based on the weight of the hydraulic binder.

The patterns in the stencil are obtained by cutting out the support of the stencil, these cut outs thereby forming <<holes>> in the support.

The stencil is preferably made in a support which has at least one surface, which will be in contact with the hydraulic binder composition which is impervious to water. The surface, which will be in contact with the deactivating composition (A) may also be impervious to water. The surface which will be in contact with the hydraulic binder composition may, preferably after the setting of the concrete, allow easy detachment of the stencil.

Preferably, the stencil is made in a support of the cellulose type, notably paper or cardboard; metal or plastic, preferably cellulose or plastic. The stencil may for example be made in siliconed paper or plastic or polyethylene which is a polymer known to be hydrophobic and having low adhesion properties thereby allowing easy detachment. Preferably, the paper and the cardboard are treated in order to make at least one of their surfaces impervious to water. More preferably, the stencil is made in a Kraftliner paper comprising, on at least one of its surfaces, a polyethylene coating. Within the scope of the present invention, by Kraftliner is meant reference to Kraft papers consisting of fresh wood fibers.

The surface of the stencil in contact with the concrete may also advantageously be coated over all or part of its surface with a composition giving the possibility of facilitating the detachment of the stencil after setting of the hydraulic binder composition. This composition may be a mould-removal composition, notably a paraffin, a vegetable oil, a mineral oil, an animal oil, mixtures thereof or emulsions of these oils with water. The stencil may for example be made in paper Graphic Concrete Smooth™ available from Graphic Concrete.

In a particular embodiment, the surface of the stencil in contact with the hydraulic binder composition may entirely or partly be covered with a deactivating composition (C), notably as described in EP 1 177 081. This deactivating layer may further create patterns on the surface of the concrete, notably as described in EP 1 177 081. Preferably, the retardant of the deactivating composition (C) has a different strength of attack, smaller or higher, preferably smaller than that of the retardant of the deactivating composition (A). This allows creation of a pattern on the surface of the concrete with different digging strengths.

The deposition of the stencil on the fresh concrete surface may cause the formation of air lenses and/or water lenses at the surface of the fresh concrete which may be very difficult to remove even by smoothing the surface. In order to overcome this problem, the stencil is preferably perforated on 5 to 95% of its surface and/or the average distance separating two holes is comprised between 3 mm and 50 cm, preferably between 5 mm and 5 cm. This stencil topography advantageously gives the possibility of easily and substantially removing the air lenses and/or the water lenses, which will have formed at the surface of the hydraulic binder composition between the hydraulic binder composition and the stencil, by smoothing.

Air bubbles may also originate from the air outflow from the hydraulic binder composition. In order to limit or even reduce this phenomenon, the hydraulic binder composition is advantageously, after casting and before application of the stencil, floated.

The deactivating compositions (A), (B) and (C) are preferably deactivating compositions conventionally used in positive deactivation. These compositions comprise a setting retardant. They may be in the form of a dispersion or solution of retardant for the setting of the hydraulic binder composition in an aqueous, oily solvent, an emulsion or a petroleum cut.

Within the scope of this discussion, as regards the deactivating compositions (A), (B) and (C), by the term of <<setting retardant>> is meant the designation of a compound having the effect of delaying the setting of the hydraulic binder composition, i.e. retarding or inhibiting phenomena related to this setting such as hydration phenomena, consequently inducing more belated hardening of the composition. Generally, a setting retardant extends the time for setting of a hydraulic binder based composition in which it has been introduced at a dose of at most 5% by dry weight based on the weight of said hydraulic binder, the setting time being measured according to the EN480-2 test. Preferably, the setting time is delayed by at least 30 minutes as compared with a composition based on a control hydraulic binder. Within the scope of the invention, by <<oily solvent>> is meant a solvent comprising fat of vegetable, animal or mineral origin, which may be liquid at room temperature or not. However, when they are not liquid at room temperature, the composition is preferably prepared under hot conditions.

The vegetable oil may notably be selected from grape seed oil, palm oil, coprah oil, castor oil, groundnut oil, grape pip oil, maize oil, canola oil, flax oil, coconut oil, soya bean oil, sunflower oil and mixtures thereof.

The animal oils may be in particular selected from tallow, wool grease, lard oil, herring oil, cod liver oil, sardine oil, fish oil and lanolin oil and mixtures thereof.

The mineral oils may notably be aliphatic, paraffinic or naphthenic oils, they include in particular the fractions including on average 8 to 30 carbon atoms, preferably 11 to 25 carbon atoms, alone or as a mixture, notably clear mineral oil. Preferred oils will be mineral oils C_{n H}₂ₙ₊₂, with n comprised between 8 and 19.

Within the scope of the present invention, by <<emulsion>> is meant the designation of both water-in-oil emulsions and oil-in-water emulsions, the oil is notably selected from the oils mentioned above.

The retardant of the deactivating composition according to the invention is selected from compounds known for this effect.

The setting retardant for the deactivating composition in an aqueous solvent may be selected from compounds known for this effect, such as carboxylic acids, their salts and their derivatives; carbohydrates, notably sugars, their salts and derivatives; but also ligno-sulfonic acid, phosphonic acids in particular those bearing amino or hydroxy groups, their salts and their derivatives; or inorganic acids such as phosphoric acid, their salts and derivatives.

Within the scope of the present invention, the derivatives of carboxylic acids, of carbohydrates, of ligno-sulfonic acids, phosphonic acids in particular those bearing amino or hydroxy groups; and inorganic acids also include the salts of these derivatives.

Within the scope of the composition according to the invention, the setting retardant of the deactivating composition in an aqueous solution is preferably selected from carboxylic acids, their salts and their derivatives; sugars, their salts and their derivatives; or one of their mixtures.

Among sugars, the setting retardant for the deactivating composition may particularly be selected from glucose, fructose, saccharose, Meritose, lactose, maltotriose, dextrose, maltose, galactose, mannose, glycogen or one of their mixtures.

Among carboxylic acids, mention may in particular be made of hydroxycarboxylic acids and from among the latter, notably citric acid, tartaric acid, malic acid, gluconic acid, maleic acid and lactic acid, their salts or one of their mixtures.

Among carboxylic acid salts, mention may be made of sodium salts, calcium salts or potassium salts. As a particular example, mention may be made of sodium citrate, sodium tartrate or sodium gluconate.

Derivatives of carboxylic acids are notably meant to designate their salts and esters, as a particular example, mention may be made of ethyl acetate.

When these are hydroxycarboxylic acids, the derivatives include lactones.

The setting retardant for the deactivating composition in an oily solution may be selected from the compounds known for this effect, such as those disclosed in EP 2 935 140, notably soluble hydroxycarboxylic acid alkyl esters in oil/solvents or dispersible in oils/solvents. For example, this is a citric acid alkyl ester such as triethyl citrate.

The retardant of the deactivating composition used in the emulsions may be selected from retardants in an aqueous solvent and from retardants in an oily solvent as defined above.

The retardant of the deactivating composition in solution in an emulsion, notably in an oil-in-water emulsion may be selected from carboxylic or hydroxycarboxylic acids which may include a saturated or unsaturated carbon chain and have one, two or three hydroxyl groups, it may also be in the form of a salt, notably a sodium salt, a potassium salt or a calcium salt. The acid is preferably selected from acetic acid, gluconic acid, citric acid, tartaric acid, maleic acid, their mixtures or their salts. Citric acid, malic acid and tartaric acid are particularly preferred. In the case of an emulsion of oil-in-water, the emulsion preferably comprises from 5 to 50% by weight of oily phase, preferably from 10 to 40% and from 50 to 95% by weight of aqueous phase, preferably from 60 to 90%. In the case of an emulsion, the deactivating composition further comprises a surfactant. For oil-in-water emulsions, the surfactant is preferably a non-quaternary amino surfactant. Such oil-in-water emulsions are described in FR1058791.

The setting retardant for the deactivating composition in solution in petroleum cuts may be selected from the aforementioned retardants for aqueous or oily phases which are milled and then dispersed within petroleum cuts.

The composition of deactivating agent (A), (B) or (C) according to the invention, comprises from 0.1 to 20% by weight, based on the weight of the setting retardant composition.

The setting retardants for the deactivating compositions (A) and (B) or (A) and (C) have a different strength of attack. Thus, the retardant of the deactivating composition (B) has a lower attack strength than that of the deactivating composition (A) and the retardant for the deactivating composition (C) has a lower or greater strength of attack, preferably lower, than that of the deactivating composition (A).

Advantageously, the deactivating compositions (A) and (B) are of the same nature, i.e. they comprise solvents of the same nature for example water, oil, water-in-oil emulsion, oil-in-water emulsion, petroleum cut. Preferably, the deactivating compositions (A) and (B) only differ by the retardant and its strength of attack as well as by the nature of optional additives.

The deactivating compositions (A) and (B) may be applied by any technique known to one skilled in the art, preferably by spraying.

The deactivating composition (C) may be applied by any technique known to one skilled in the art, for example by means of a printing technique or an output technique. Mention may for example be made of screen printing, flexography, offset printing or a digital output technique, such methods are notably described in EP 1 177 081.

The deactivating compositions (A), (B) or (C) may optionally contain additives allowing improvement of its properties, such as fillers, opacifying agents, antifoam agents, surfactants, curing agents, biocidal agents, thickeners, pigments, wetting agents, plasticizers, film-forming agents or dispersants.

In particular, it is possible to add suitable agents for adjusting the rheological properties of the composition according to the invention so as to allow easy application by spraying.

Preferably, these agents are present in the deactivating composition at contents not exceeding 15% by weight, and preferably not exceeding 10% by weight.

The curing agents are notably selected from vegetable oils, animal oils or mineral oils such as those described above.

The curing agents may also be selected from resins solubilized in a solvent, as described in FR2828192, styrene-butadiene latices, aqueous emulsions of acrylic resin as described in EP 1 661 874, paraffinic emulsions, acrylic polymers.

In a particular embodiment, the hydraulic binder composition may be subject before, during or after creation of the pattern on all or part of its surface, to any type of aesthetical treatment known aiming at protecting it, coloring it. For example it may, during the creation of the pattern, on all or part of the surface, be subject to a mineralizing treatment (or curing treatment), notably allowing coloration to be induced. It may also, after creation of the pattern on all or part of its surface, be covered with a protective product. The protective product is typically applied on hardened compositions with the purpose of protecting it notably from external aggressions. Such products are known to one skilled in the art. The treated surface may be both, the surface of the areas intended to produce the pattern or the surface of the areas having the pattern, and the surrounding areas.

The surface may also, after creation of the patterns be subject to mechanical treatments known to one skilled in the art, such as polishing, sanding . . .

The invention also relates to an alternative method for creating patterns on a surface of a hydraulic binder composition, comprising the deposition on the surface of the fresh hydraulic binder composition of a stencil, the face of which in contact with the hydraulic binder composition is covered with a deactivating composition (C).

The hydraulic binder composition, the stencil and the deactivating composition (C) are as defined above. Said method may further comprise steps for aesthetical treatments as described above.

The present invention will now be described by means of non-limiting examples.

### EXAMPLES

### Example 1

In a conventional building site cement mixer, are introduced 85 kg of granulates Palvadeau 4/8and 94.5 kg of recomposed sand Palvadeau 0/4. The cement mixer is started and then are added, after about 1 minute, 33 kg of white cement CEM I 52.5N Blanc and 2 kg of lime stone filler. Next 20 liters of water are added, into which 230 g of CHRYSO®Fluid Optima 175 have been added beforehand. The whole is kneaded in the cement mixer for 4 min. The thereby obtained concrete is of consistency S3 (a concrete for which the measured collapse according to the NF EN12350-2 standard is comprised between 100 and 150 mm). The concrete is set into place in the form described hereafter, and this operation is renewed 3 times in order to have available a total of 400 L of concrete (4*100 L).

The form is a steel form of dimensions 1 m*4 m*0.10 m in the bottom of which a 2 cm thick polystyrene has been placed. After setting into place the last mix, the surface of the concrete is smoothed with an American trowel called a Flemish trowel. Immediately after smoothing, the stencil consisting of a membrane of the Graphic Concrete Smooth™ type, in which patterns have been cut out, is laid flat down on the surface of fresh concrete, and it is again proceeded with smoothing by means of the same Flemish trowel in order to have the stencil adhere to the surface. When this operation is completed, a deactivating agent, in this case CHRYSO®Deco Lay P03, is sprayed over the whole surface by means of a CHRYSO®Pulvo Plastique sprayer. 22 h afterwards, the stencil is removed manually and the thereby exposed surface is entirely washed by means of a high pressure cleaner, which gives the possibility of showing the deactivated portions, while the portions in direct contact with the stencil remain smooth.

### Example 2

The preceding example is reproduced with the following concrete composition:

| Component | kg/m³ of concrete |
|---|---|
| Rolled alluvial 4/10 gravel | 1080 |
| Alluvial rolled sand 0/4 | 470 |
| Alluvial rolled sand 0/1 | 130 |
| Cement CEM I 52.5N CP2 | 300 |
| Le Havre | |
| Limestone filler | 80 |
| Water | 190 |
| CHRYSO ®Fluid Optima 224 | 0.9% by weight of binder |
| | (cement + limestone filler) |
| CHRYSO ®Air R² | 0.1% by weight of binder |
| | (cement + limestone filler) |
| CHRYSO ®Fibre Syntec 12 | 600 g |

The surface of the obtained concrete has smooth surfaces and deactivated surfaces showing patterns.

1. A method for creating patterns on a surface of a hydraulic binder composition comprising deposition on the surface of the fresh hydraulic binder composition of a stencil and then application of a deactivating agent composition (A) on the thereby covered surface.

2. The method according to claim 1, further comprising a step before depositing the stencil, of applying, on all or part of the surface of the hydraulic binder composition, a deactivating agent composition (B) having a lower strength of attack than that of composition (A).

3. The method according to claim 1, wherein the fresh hydraulic binder composition has an open time of at least 30 minutes.

4. The method according to claim 1, wherein the hydraulic binder composition comprises at least one retardant and/or fluidifying additive.

5. The method according to claim 4, wherein the retardant and/or fluidifying additive is selected from polymers with a comb structure, compounds comprising a polyalkoxylated chain and at least one amino-alkylene phosphonic group, gluconic acid, sugars, lignosulfonic acids, polynaphthalene sulfonic acid, polymelamine sulfonic acid and their salts; alone or as a mixture.

6. The method according to claim 5, wherein the additive is selected from comb copolymers with a main polycarboxylate chain bearing side chains grafted with polyalkyleneoxide, the compounds comprising a polyalkoxylated chain and at least one amino-alkylene phosphonic group, alone or as a mixture.

7. The method according to claim 4, wherein the additive is present in a concentration from 0.2 to 3% by dry weight based on the weight of hydraulic binder in the hydraulic binder composition.

8. The method according to claim 1, wherein the stencil is made in a support of the cellulose, plastic or metal type.

9. The method according to claim 8, wherein the surface of the stencil which will be in contact with the fresh hydraulic binder composition is coated with a mold-removal composition comprising a paraffin, a mineral oil, a vegetable oil, mixtures thereof and emulsions of these oils.

10. The method according to claim 8, wherein the stencil is made in a support of the Kraftliner paper type comprising, on at least one of its surfaces, a coating of polyethylene.

11. The method according to claim 1, wherein the patterns on the stencil are obtained by cutting out thereby forming holes, the stencil being perforated on 5 to 95% of its surface and/or the average distance between two holes is comprised between 3 mm and 50 cm.

12. The method according to claim 1, wherein the surface of the support which will be in contact with the fresh hydraulic binder composition is coated, totally or partly with a deactivating composition (C) having a different strength of attack from that of the composition (A).

13. The method according to claim 1, wherein the deactivating compositions (A), (B) and (C) appear as a dispersion or solution of a setting retardant in an aqueous, oily, solvent and emulsion, a petroleum cut.

14. The method according to claim 1, further comprising one or several other esthetical or mechanical treatments of the surface of the hydraulic binder composition before or after formation of the patterns.
